(19) United States
(12) Patent Application Publication
(10) Pub. No.: US 2026/0192647 A1
(43) Pub. Date: Jul. 9, 2026

(54) Wrench system and a car cover with the wrench system

(71) Applicant: Wenzhou Tianmao Automobile Parts Co.,Ltd, Wenzhou City, (CN)

(72) Inventors: Lanhua Cai, Ruian City, (CN); Xianzu Chen, Ruian City (CN)

(21) Appl. No.: 19/013,437

(22) Filed: Jan. 8, 2025

(51) Int. Cl. B60J 7/19

(52) U.S. Cl. CPC B60J 7/198

(57) ABSTRACT

The present invention discloses a new wrench system that includes a wrench, the wrench includes an upper wrench, a lower wrench, a rotating assembly and a limiting assembly, the lower wrench is provided with a first through-hole, the rotating assembly is rotationally connected to the lower wrench with one end of the rotating assembly passing through the upper wrench, the limiting assembly includes a cylindrical cylinder, the cylindrical cylinder is detachably connected to the first through-hole, the cylindrical cylinder is used for limiting the rotating assembly. By setting the limiting assembly, the present utility model preventing the rotating assembly from rotating and preventing the wrench from loosening by limiting the rotating assembly with the limiting assembly when the wrench locks the car cover tightly.

### CROSS-REFRENCE TO RELATED APPLICATIONS

The application claims priority of Chinese patent application CN202311523875.5, filed on Nov. 14, 2023, which is incorporated herein by reference in its entireties.

### TECHNICAL FIELD

This invention is relevant to automotive spare parts, especially a new wrench system.

### BACKGROUND TECHNOLOGY

Pickup trucks, also known as coupe trucks, which has both car-like comfort, without losing the strong power, as well as its comprehensive performance makes it one of the common models of off-road vehicles now.

Most of the existing pickup trucks only have a hopper without cover, which seriously affects the use of pickup trucks in the rain and snow days, therefore, many owners will add a cover to the pickup truck. As the cover is added, so in the installation, we must first install the side rails along both sides of the hopper, and then connect the cover with the side rails. To facilitate the opening of the car cover, most of the side rails currently use a wrench structure, due to the fact that pickup trucks are often driven on some protrusion roads, the wrench in the wrench structure is prone to loosening, resulting in the inability to lock the car cover well, in serious cases, it may result in the slipping off of the car cover, which is a big safety hazard.

### ABOUT THE INVENTION

To overcome the deficiencies of the prior art, the present invention provides a new wrench system that avoids loosening of the wrench assembly during driving by adding a limiting assembly. In order to solve the above problems of the existing technology, the technical solution adopted in the invention is as follows:

A new wrench system includes a wrench, the wrench includes an upper wrench, a lower wrench, a rotating assembly and a limiting assembly.

The lower wrench is provided with a first through-hole.

The rotating assembly is rotationally connected to the lower wrench with one end of the rotating assembly passing through the upper wrench.

The limiting assembly includes a cylindrical cylinder, which is detachably connected to the first through-hole, the cylindrical cylinder is used for limiting the rotating assembly.

By setting the limiting assembly, when the wrench locks the car cover, the limiting assembly is used to limit the rotating assembly, preventing the rotating assembly from rotating and thus preventing the wrench from loosening.

Further, the upper wrench is provided with a wrench groove and a connecting hole, the cylindrical cylinder passes through the connecting hole, the wrench groove is used to clamp with the car body or the side rails, by setting the connecting hole, the cylindrical cylinder passes through the connecting hole to make the rotating assembly stably connected with the upper wrench, the rotating assembly includes a T-rod and a rotation axis, the T-rod is rotationally connected to the lower wrench through the rotation axis, the lower wrench is further provided with a second through-hole, the second through-hole and the first through-hole are provided on both sides of the T-rod respectively, by setting the second through-hole, the cylindrical cylinder can be inserted into the second through-hole when it is limited to a certain position. The first through-hole is provided on the side where the lower wrench is rotated to release, thus connecting the cylindrical cylinder to the first through-hole can achieve the restriction of the lower wrench, the second through-hole is set on the other side, so that when the lower wrench is rotated, the cylindrical cylinder will not affect the rotation of the lower wrench.

Further, one end of the cylindrical cylinder is connected with an end cap, the other end of the cylindrical cylinder is provided with a telescopic limiting body, the cylindrical cylinder is made of stainless steel, by setting the telescopic limiting body, the end of the cylindrical cylinder is limited by the end cap with a larger diameter, the other end of the cylindrical cylinder is automatically limited by the telescopic limiting body, which is convenience to use. The cylindrical cylinder is provided with a telescopic cavity, the telescopic limiting body is provided in the telescopic cavity, the telescopic limiting body includes a spring and a telescopic ball, one end of the spring resists against the telescopic ball, the other end of the spring resists against the telescopic cavity. Alternatively the telescopic limiting body includes two telescopic balls with a spring connected between the two telescopic balls, the spring is in a compressed state. The cylindrical cylinders can be of various structures, and the cylindrical cylinders are prior art and are directly transferable herein.

Further, the upper wrench is provided with a travelling slot, the lower wrench is provided with a travelling bump, the travelling bump extending into the travelling slot. As the rotation centre of the rotating assembly is a rotation axis, and the distance of the rotation centre from the top of both sides of the lower wrench is different, the wrench system is in a loosening state when the upper wrench is rotated to the side of the lower wrench, the wrench system is in a locking state when the upper wrench is rotated to the top of the lower wrench. The wrench system is locked by topping the lower wrench with the upper wrench to tighten the T-rod. The lower wrench is provided with two limiting bezels, the upper wrench is provided with two limiting protrusions, the two limiting bezels are provided in correspondence with the two limiting protrusions, the limiting bezels are overlapped with the limiting protrusions, by setting the limiting protrusions and the limiting bezels, it prevents the upper wrench from being detached from the lower wrench. The end cap is provided with a circular hole, the circular hole is connected with a first ring. The lower wrench is further provided with a connecting crossbeam, the connecting crossbeam is connected to the first ring by an anti-loss rope. The anti-loss rope is a steel wire or a plastic rope. A second ring can also be connected, wherein one end of the anti-loss rope is connected to the connecting crossbeam by the second ring, the other end of the anti-loss rope is connected to the first ring, the first ring and the second ring are made of stainless steel or plastic. By setting the connecting crossbeam, it can increase the force strength of the lower wrench on the one hand, and on the other hand, it can connect the cylindrical cylinder with the lower wrench through the first ring and the anti-loss rope, so as to prevent the cylindrical cylinder from falling and being lost.

Further, the T-rod includes a horizontal rod and a vertical rod, the vertical rod is connected to a rotation axis, the horizontal rod is connected to the vertical rod, the horizontal rod is located on the side of the upper wrench away from the lower wrench, the vertical rod is rotationally connected with the lower wrench, the horizontal rod is used for limiting in cooperation with the wrench slider, it further includes a wrench slider, the wrench slider is used for limiting the rotating assembly, the wrench slider is provided with a connecting groove, the vertical rod passes through the connecting groove, the horizontal rod clamps with the wrench slider, the car body is provided with a side rail, the side rail is provided with a curved edge, the car cover is provided with a wrench groove, the wrench slider is provided in the wrench groove. the horizontal rod passes through the wrench slider and clamps with the wrench slider, the wrench groove is clamped to the curved edge.

The beneficial effects of the present invention are:

By setting the limiting assembly, the present invention prevents the wrench from loosening by limiting the rotating assembly with the limiting assembly when the wrench locks the car cover tightly.

2. By setting the connecting crossbeam, it can increase the force strength of the lower wrench on the one hand, and on the other hand, it can connect the cylindrical cylinder with the lower wrench through the first ring and the anti-loss rope, so as to prevent the cylindrical cylinder from falling and being lost.

### DESCRIPTION OF FIGURE

FIG. 1 is a structural schematic diagram I of the present invention.

FIG. 2 is a structural schematic diagram II of the present invention.

FIG. 3 is an usage schematic diagram III of the present invention.

FIG. 4 is a main view of the present invention.

FIG. 5 is a sectional view in the direction of A-A in FIG. 4.

FIG. 6 is a side view of the present invention.

FIG. 7 is a sectional view in the direction B-B in FIG. 6.

FIG. 8 is a usage schematic diagram I of the present invention.

FIG. 9 is a usage schematic diagram II of the present invention.

FIG. 10 is a structural schematic diagram of a lower wrench in the present invention.

FIG. 11 is a structural schematic diagram of an upper wrench in the present invention.

FIG. 12 is a schematic diagram of embodiment 3.

Figures: 1—Wrench; 11—Wrench groove; 12—Cylindrical cylinder post; 1201—Circular hole; 1202—Telescopic limiting body; 13—First ring; 14—Second ring; 15—Anti-loss rope; 16—Lower wrench; 1601—First through-hole; 1602—Connecting crossbeam; 1603—Second through-hole; 1604—Travelling protrusion; 1605—Limition bezel; 17—Upper wrench; 1701—Connecting hole; 1702—Travelling slot; 1703—Limiting protrusion; 2—Wrench slider; 3—Side rail; 31—Curved edge; 4—T-rod; 401—Vertical rod; 402—Horizontal rod; 403—Rotation axis.

### THE CONCRETE METHOD TO CARRY OUT

The following instruction further explains the invention's concrete implementation method.

In order to enable a clearer understanding of the objects mentioned above, features and advantages of the present invention, the invention is described in detail below in connecting with the accompanying Figure and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying Figure. It should be understood that the specific embodiments described herein are intended only to illustrate and explain the present invention and not to limit it.

### Embodiment 1

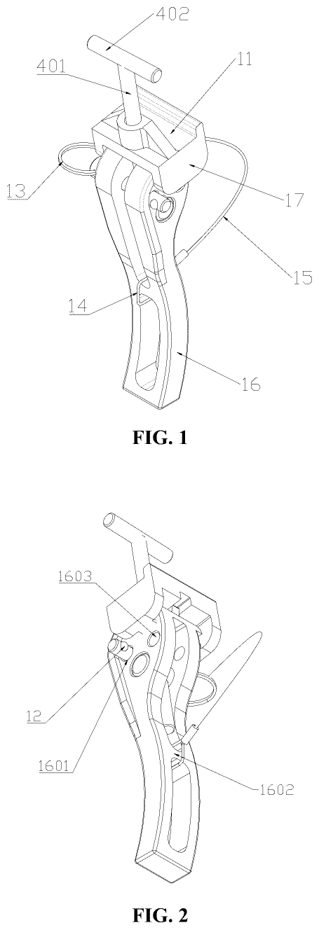

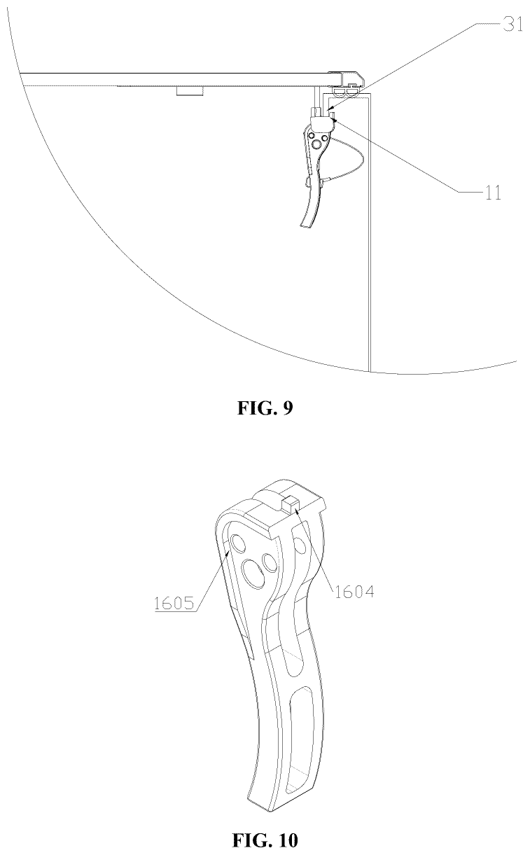

As shown in FIGS. 1, 2, 8 and 9, a new wrench system includes a wrench 1, the wrench 1 includes an upper wrench 17, a lower wrench 16, a rotation assembly and a limiting assembly.

The lower wrench 16 is provided with a first through-hole 1601.

The rotation assembly is rotationally connected to the lower wrench 16 with one end of the rotation assembly passing through the upper wrench 17.

The limiting assembly includes a cylindrical cylinder 12, the cylindrical cylinder 12 is detachably connected to the first through-hole 1601, the cylindrical cylinder 12 is used for limiting the rotating assembly.

By providing the limiting assembly, when the wrench 1 locks the car cover, the limiting assembly is used to limit the rotating assembly, preventing the rotating assembly from rotating and thus preventing the wrench 1 from loosening.

When in use, the lower wrench 16 is rotated so that the lower wrench 16 pushes the upper wrench 17 upwardly and clamps with the side rail 3, and the limiting assembly is then connected to the first through-hole 1601, the limiting assembly limits the rotating assembly and prevents the rotating assembly from rotating.

### Embodiment 2

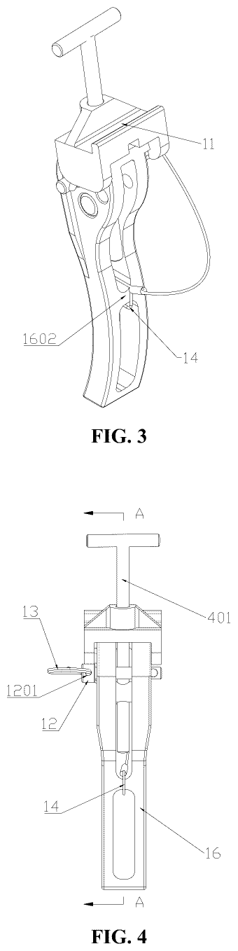

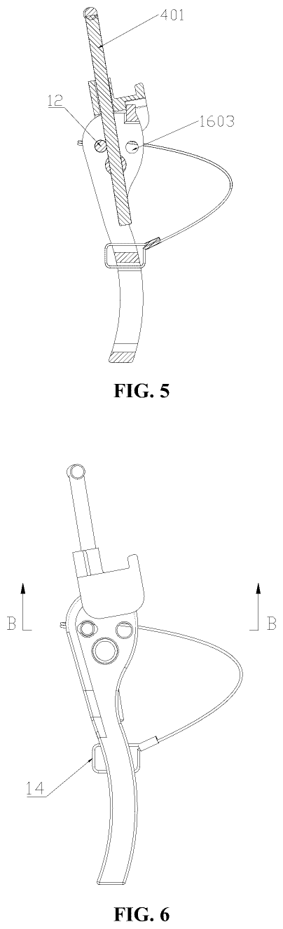

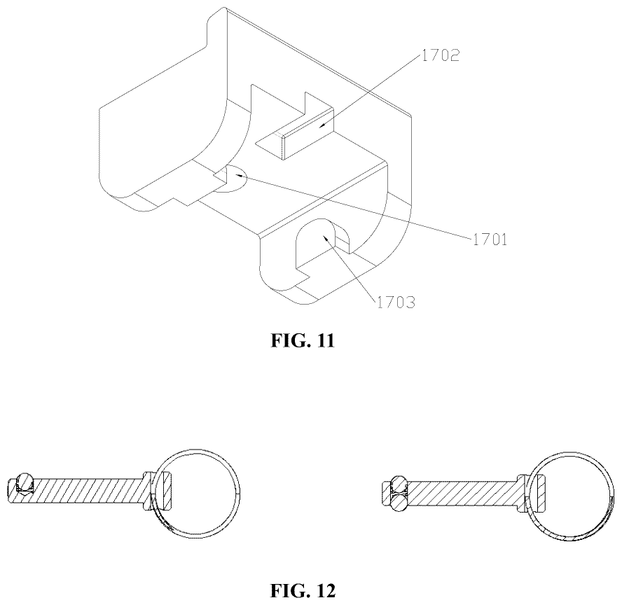

On the basis of Embodiment 1, as shown in FIGS. 3-5 and 11, the upper wrench 17 is provided with a wrench groove 11 and a connecting hole 1701, the cylindrical cylinder 12 passes through the connecting hole 1701, the wrench groove 11 is used to clamp with the car body or the side rails 3.

By setting the connecting hole 1701, the cylindrical cylinder 12 passes through the connecting hole 1701 to make the rotating assembly stably connected with the upper wrench 17.

The rotating assembly further includes a T-rod 4 and a rotation axis 403, the T-rod 4 is rotationally connected to the lower wrench 16 through the rotation axis 403.

The lower wrench 16 is further provided with a second through-hole 1603, the second through-hole 1603 and the first through-hole 1601 are provided on both sides of the T-rod 4 respectively.

By setting the second through-hole 1603, the cylindrical cylinder 12 can be inserted into the second through-hole 1603 when it is limited to a certain position.

When in use, if the car cover is to be opened, the cylindrical cylinder 12 is first removed from the first through-hole 1601 and inserted into the second through-hole 1603 to prevent the cylindrical cylinder 12 from being lost, then the lower wrench 16 is rotated to release the upper wrench 17 from the side rails 3, so as to open the car cover.

The first through-hole 1601 is provided on the side where the lower wrench 16 is rotated to release, so that connecting the cylindrical cylinder 12 to the first through-hole 1601 can achieve the restriction of the lower wrench 16, the second through-hole 1603 is set on the other side, so that when the lower wrench 16 is rotated, the cylindrical cylinder 12 will not affect the rotation of the lower wrench 16.

### Embodiment 3

On the basis of Embodiment 2, as shown in FIG. 12, one end of the cylindrical cylinder 12 is connected with an end cap (not shown in the drawings), the other end of the cylindrical cylinder 12 is provided with a telescopic limiting body 1202, the cylindrical cylinder 12 is made of stainless steel.

By setting the telescopic limiting body 1202, one end of the cylindrical cylinder 12 is limited by the end cap of a larger diameter, the other end of the cylindrical cylinder 12 is automatically limited by the telescopic limiting body 1202, which is convenient to use.

When it is necessary to insert the cylindrical cylinder 12, push the cylindrical cylinder 12 with force, the telescopic limit body 1202 shrinks under the extrusion, and the telescopic limiting body 1202 elongates and clamps tightly after it passes through the first through-hole 1601, at that time the cylindrical cylinder 12 can not be retracted, so as to realise the limiting position.

When the cylindrical cylinder 12 needs to be removed, press the two ends of the telescopic limiting body 1202 manually, and pull the cylindrical cylinder 12 outward at the same time.

The cylindrical cylinder 12 is provided with a telescopic cavity (not shown in the drawings), the telescopic limiting body 1202 is provided in the telescopic cavity, the telescopic limiting body 1202 includes one or two telescopic balls.

The cylindrical cylinder 12 can be of various structures, the cylindrical cylinders 12 are prior art and are directly transposed herein.

The telescopic limiting body 1201 is a spring and a telescopic ball, one end of the spring resists the telescopic ball, the other end of the spring resists the telescopic cavity.

The telescopic limiting body 1201 includes a spring and two telescopic balls, both ends of the spring resting against each of the two telescopic balls.

In case the telescopic limiting body 1201 is two telescopic balls, a spring is provided between the two telescopic balls. In case the telescopic limiting body 1201 is a small telescopic ball, a spring is provided between the small telescopic ball and the limiting cavity, and the spring is in a compressed state.

### Embodiment 4

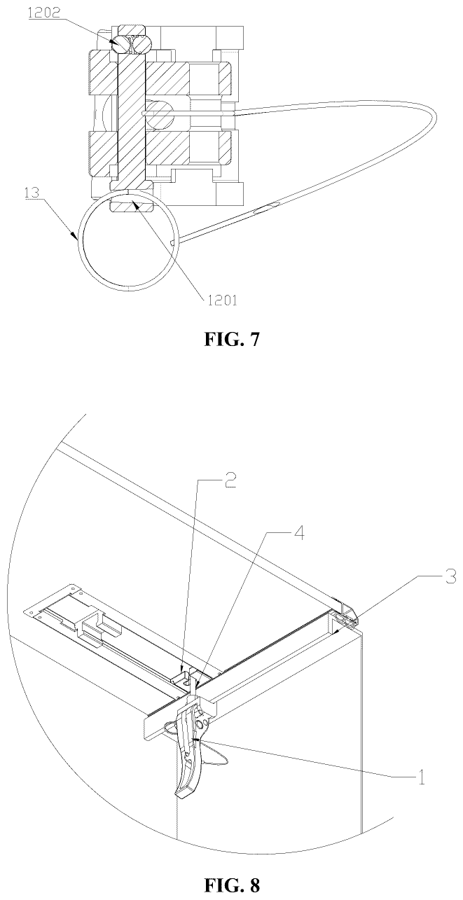

On the basis of embodiment 3, as shown in FIGS. 6, 7 and 10, the upper wrench 17 is provided with a travelling slot 1702, the lower wrench 16 is provided with a travelling bump 1604, the travelling bump 1604 extends into the travelling slot 1702.

When the lower wrench 16 rotates to the locking position, the travelling bump 1604 resists the bottom of the slot in the travelling slot 1702, in which case the lower wrench 16 is unable to rotate any further.

As the rotation centre of the rotation assembly is the rotation axis 403, and the distance of the rotation centre from the top of both sides of the lower wrench 16 is different, the wrench 1 system is in a loosening state when the upper wrench 17 is rotated to the side of the lower wrench 16, the wrench 1 system is in a locking state when the upper wrench 17 is rotated to the top of the lower wrench 16, the wrench 1 system is locked by topping the lower wrench 16 with the upper wrench 17 to tighten the T-rod 4.

The lower wrench 16 is provided with two limiting bezels 1605, the upper wrench 17 is provided with two limiting protrusions 1703, the two limiting bezels 1605 are provided in correspondence with the two limiting protrusions 1703, the limiting bezels 1605 are overlapped with the limiting protrusions 1703, by setting the limiting protrusions 1703 and the limiting bezels 1605, it prevents the upper wrench 17 from being detached from the lower wrench 16.

The end cap is provided with a circular hole 1201, the circular hole 1201 is connected to a first ring 13.

The lower wrench 16 is further provided with a connecting crossbeam 1602, the connecting crossbeam 1602 is connected to the first ring 13 by an anti-loss rope 15.

In addition to this, a second ring 14 can be connected to the connecting crossbeam 1602, the second ring 14 is connected to the first ring 13 by an anti-loss rope 15, the anti-loss rope 15 is a steel wire or a plastic rope, the first ring 13 and the second ring 14 are made of stainless steel or plastic.

By setting the connecting crossbeam 1602, it can increase the force strength of the lower wrench 16 on the one hand, and on the other hand, it can connect the cylindrical caliper 12 with the lower wrench 16 through the first ring 13, the anti-loss rope 15 and the second ring 14, so as to prevent the cylindrical caliper 12 from falling and being lost.

### Embodiment 5

On the basis of embodiment 4, the T-rod 4 includes a horizontal rod 402 and a vertical rod 401, the vertical rod 401 is connected to the rotation axis 403, the horizontal rod 402 is connected to the vertical rod 401, the horizontal rod 402 is located on the side of the upper wrench 17 away from the lower wrench 16.

The vertical bar 401 is rotationally connected with the lower wrench 16, the horizontal bar 402 is used for limiting in cooperation with the wrench slider.

It further includes a wrench slider 2, the wrench slider 2 is used for limiting the rotating assembly.

The wrench slider 2 is provided with a connecting groove, the vertical rod 401 passes through the connecting groove, the horizontal rod 402 clamps together with the wrench slider 2.

The car body is provided with a side rail 3, the side rail 3 is provided with a curved edge 31.

The car cover is provided with a wrench groove, the wrench slider 2 is provided in the wrench groove.

The horizontal rod 402 passes through the wrench slider 2 and clamps with the wrench slider 2, the wrench groove 11 is clamped to the curved edge 31.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A new wrench system, wherein, it includes a wrench (1), the wrench (1) includes an upper wrench (17), a lower wrench (16), a rotating assembly and a limiting assembly;
The lower wrench (16) is provided with a first through-hole (1601);
The rotating assembly is rotationally connected to the lower wrench (16) with one end of the rotating assembly passing through the upper wrench (17);
The limiting assembly includes a cylindrical cylinder (12), the cylindrical cylinder (12) is detachably connected to the first through-hole (1601), the cylindrical cylinder (12) is used for limiting the rotating assembly.

2. The new wrench system according to claim 1, wherein, the upper wrench (17) is provided with a wrench groove (11) and a connecting hole (1701), the cylindrical cylinder (12) passes through the connecting hole (1701), the wrench groove (11) is used to clamp with the car body or the side rails (3).

3. A new wrench system according to claim 2, wherein, the rotating assembly includes a T-rod (4) and a rotation axis (403), the T-rod (4) is rotationally connected to the lower wrench (16) through the rotation axis (403);
The lower wrench (16) is further provided with a second through-hole (1603), the second through-hole (1603) and the first through-hole (1601) are provided on both sides of the T-rod (4) respectively.

4. A new wrench system according to claim 1, wherein, the upper wrench (17) is provided with a travelling slot (1702), the lower wrench (16) is provided with a travelling protrusion (1604), the travelling protrusion (1604) extends into the travelling slot (1702).

5. A new wrench system according to claim 4, wherein, the lower wrench (16) is provided with two limiting bezels (1605), the upper wrench (17) is provided with two limiting protrusions (1703), the two limiting bezels (1605) are provided in correspondence with the two limiting protrusions (1703), the limiting bezels (1605) are overlapped with the limiting protrusions (1703).

6. A new wrench system according to claim 1, wherein, one end of the cylindrical cylinder (12) is connected to an end cap, the end cap is provided with a circular hole (1201), the circular hole (1201) is connected to a first ring (13);
The lower wrench (16) is further provided with a connecting crossbeam (1602), the connecting crossbeam (1602) is connected to the first ring (13) by an anti-loss rope (15).

7. A new wrench system according to claim 3, wherein, the T-rod (4) includes a horizontal rod (402) and a vertical rod (401), the vertical rod (401) is connected to a rotation axis (403), the horizontal rod (402) is connected to the vertical rod (401), the horizontal rod (402) is located on the side of the upper wrench (17) away from the lower wrench (16).

8. A new wrench system according to claim 7, wherein, it further includes a wrench slider (2), the wrench slider (2) is used for limiting the rotating assembly;
The wrench slider (2) is provided with a connecting groove, the vertical rod (401) passes through the connecting groove, the horizontal rod (402) clamps together with the wrench slider (2).

9. A new wrench system according to claim 8, wherein, the car body is provided with a side rail (3), the side rail (3) is provided with curved edges (31);
The car cover is provided with a wrench groove, the wrench slider (2) is provided in the wrench groove;
The horizontal bar (402) passes through the wrench slider (2) and clamps with the wrench slider (2), the wrench groove (11) is clamped to the curved edge (31).

10. A new wrench system according to claim 6, wherein, the cylindrical cylinder (12) is provided with a telescopic cavity at the end away from the end cap, the telescopic cavity is provided with a telescopic limiting body (1202), the telescopic limiting body (1202) includes:
A spring and one telescopic ball, one end of the spring resists against the telescopic ball and the other end of the spring resisting the telescopic cavity;
Or a spring and two telescopic balls, both ends of the spring resisting against each of the two telescopic balls.
